(19) United States
(12) Patent Application Publication
(10) Pub. No.: US 2014/0327772 A1
(43) Pub. Date: Nov. 6, 2014

(54) VEHICLE VISION SYSTEM WITH TRAFFIC SIGN COMPREHENSION

(71) Applicant: MAGNA ELECTRICS INC., Auburn Hills, MI (US)

(72) Inventor: Reza Sahba, Franklin, MI (US)

(73) Assignee: MAGNA ELECTRICS INC., Auburn Hills, MI (US)

(21) Appl. No.: 14/268,169

(22) Filed: May 2, 2014

Related U.S. Application Data
(60) Provisional application No. 61/819,033, filed on May 3, 2013.

(51) Int. Cl. G06K 9/00; B60R 11/04

(52) U.S. Cl. CPC G06K 9/00818; B60R 11/04
USPC 348/148

(57) ABSTRACT

A vision system of a vehicle includes a camera disposed at a vehicle and having a field of view forward of the vehicle. The camera includes a two dimensional imaging array of a plurality of photosensing pixels and is operable to capture image data. A control includes an image processor that is operable to process image data captured by the camera. The image processor, responsive at least in part to processing of captured image data, is operable to determine road signs ahead of the vehicle, and the image processor uses a matrix algorithm for determining road signs along the road and for determining road sign information for displaying to the driver of the vehicle. The road signs may include speed limit signs and the control may, responsive at least in part to a determination of weather conditions, determine the appropriate speed limit to display to the driver.

### CROSS REFERENCE TO RELATED APPLICATION

The present application is related to U.S. provisional application, Ser. No. 61/819,033, filed May 3, 2013, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935; and/or 5,550,677, which are hereby incorporated herein by reference in their entireties.

### SUMMARY OF THE INVENTION

The present invention provides a vision system or imaging system for a vehicle that utilizes one or more cameras (preferably one or more CMOS cameras) to capture image data representative of images exterior of the vehicle, and provides the communication/data signals, including camera data or captured image data, that may be displayed at a display screen that is viewable by the driver of the vehicle, such as when the driver is backing up the vehicle, and that may be processed and, responsive to such image processing, the system may detect an object at or near the vehicle and in the path of travel of the vehicle, such as when the vehicle is backing up. The vision system detects and recognizes traffic signs along the road ahead of the vehicle and determines a history of detected and recognized signs and processes image data representative of new signs and determines whether the new sign information supplants the previous or historical sign information or adds a further limitation or the like to the previous or historical sign information or whether the new sign information is to be ignored. Responsive to such processing, the system outputs to a display to display the appropriate information for viewing by the driver of the vehicle.

According to an aspect of the present invention, a vision system of a vehicle includes a camera disposed at a vehicle and having a field of view forward of the vehicle. The camera comprises a two dimensional imaging array of a plurality of photosensing pixels and is operable to capture image data. A control includes an image processor that is operable to process image data captured by the camera. The control, responsive at least in part to processing by the image processor of captured image data, is operable to determine road signs ahead of the vehicle, and the control uses a matrix algorithm for determining road signs and for determining sign information to display to the driver of the vehicle.

Optionally, the determined road signs may comprise speed limit signs and, responsive at least in part to image processing of captured image data, the control may determine different speed limit signs and determine the appropriate speed limit for the vehicle at the vehicle's current location. The control may determine the appropriate speed limit responsive at least in part to driving conditions at the vehicle, such as to determined weather conditions at the vehicle's current location, such as rain or snow. For example, responsive at least in part to image processing of captured image data, the control may determine the presence of a first speed limit sign and a second speed limit sign, with the first speed limit sign indicating a first speed limit that is applicable during dry road conditions and the second speed limit sign indicating a second speed limit that is applicable during wet road conditions. The control may be operable to determine which of the first and second speed limits is applicable to the current road conditions/weather conditions and may display the determined appropriate speed limit for viewing by the driver of the vehicle.

Optionally, the control may be operable to utilize a history of determined road signs and new road signs in determining whether new sign information of a newly determined road sign supplants previous sign information of previously determined road signs. Responsive to a determination that new sign information supplants previous sign information, the vision system may output to a display screen to display the new sign information for viewing by the driver of the vehicle.

The vision system may be operable to store sign data as a matrix and the matrix algorithm may process the matrix to determine appropriate sign information for display to the driver. The vision system may store location data as part of the matrix.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention;

FIG. 2 shows exemplary dynamic changing signs;

FIG. 3 is a schematic showing an exemplary series of signs along a road;

FIGS. 4-6 show different traffic signs along a road;

FIGS. 7 and 8 show schematics of the vision system of the present invention;

FIG. 9-11 show matrices used by the vision system of the present invention; and

FIG. 12 is a schematic showing use of the MATLAB model for verification of traffic sign recognition software in accordance with the present invention.

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a top down or bird's eye or surround view display and may provide a displayed image that is representative of the subject vehicle, and optionally with the displayed image being customized to at least partially correspond to the actual subject vehicle.

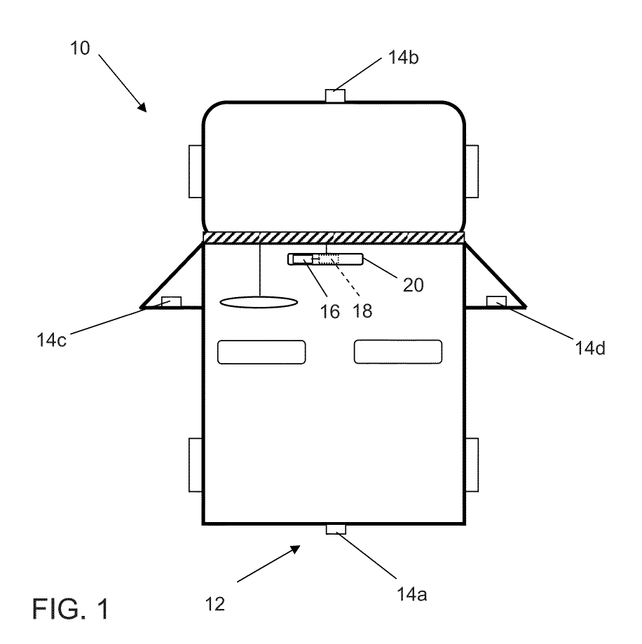

Referring now to the drawings and the illustrative embodiments depicted therein, a vehicle 10 includes an imaging system or vision system 12 that includes a forwardly facing camera, such as a camera that views through the windshield of the vehicle or is otherwise disposed at a forward portion of the vehicle and having a field of view forwardly of the vehicle and in the direction of forward travel of the vehicle. Optionally, the vision system may include more than one exterior facing imaging sensor or camera, such as a rearward facing imaging sensor or camera 14a (and the system may optionally include multiple exterior facing imaging sensors or cameras, such as a forwardly facing camera 14b at the front (or at the windshield) of the vehicle, and a sidewardly/rearwardly facing camera 14c, 14d at respective sides of the vehicle), which captures images exterior of the vehicle, with the camera having a lens for focusing images at or onto an imaging array or imaging plane or imager of the camera (FIG. 1). The vision system 12 includes a control or electronic control unit (ECU) or processor 18 that is operable to process image data captured by the cameras and may provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

The present invention provides a forward facing vision system that has a forward facing or viewing imager or camera that captures image data representative of the scene forward of the vehicle. The image processor processes (such as via an algorithm) image data to determine and identify or recognize traffic signs ahead and/or sideward of the vehicle as the vehicle travels along a road.

The system of the present invention uses a matrix laboratory (MATLAB) algorithm or programming language, such as MATLAB Simulink algorithm, for traffic sign comprehension. The system thus is operable to recognize traffic signs and their additional conditions using a camera with image processing capability. The system is operable to detect and comprehend traffic signs and displays. The reaction of the algorithm to the observation of new traffic signs on the road not only depends on the observed new sign but also depends on the previously active signs. The MATLAB numerical computing environment or programming language allows for matrix manipulations, plotting of functions and data, implementation of algorithms, creation of user interfaces, and interfacing with programs written in other languages, including C, C++, Java, and Fortran and the like. Optionally, although described as using a MATLAB or matrix laboratory algorithm to model the system and generate code, the system of the present invention may utilize C code or other suitable code or algorithm to model the system and generate the appropriate code and/or outputs, while remaining within the spirit and scope of the present invention.

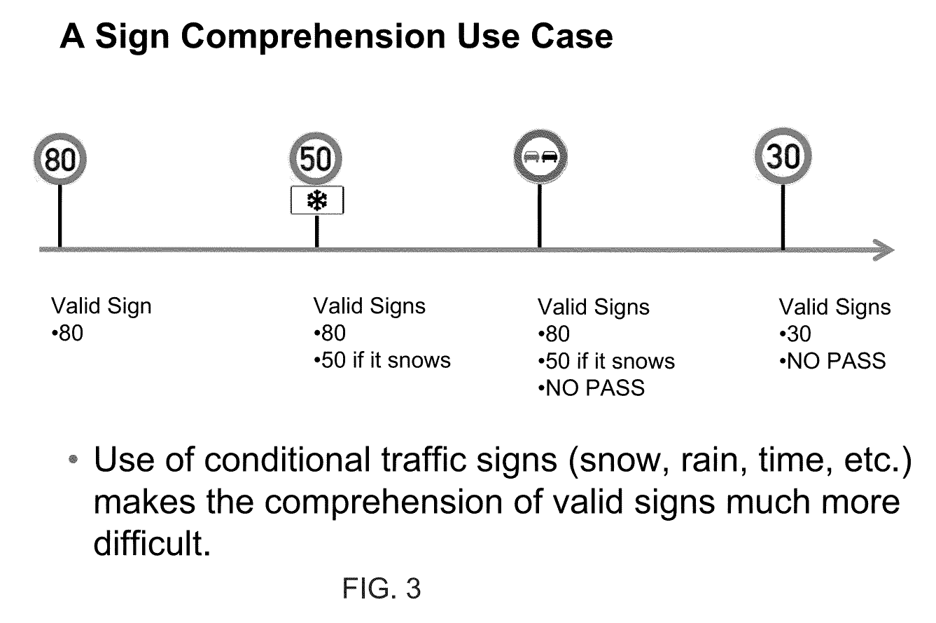

Dynamically changing speed limit traffic signs are increasing in use on roads today, particularly in Europe. Now, instead of a single speed limit sign for a section or region of road, there may be multiple signs, any one or more of which may be activated or valid depending on the driving conditions. For example, and with reference to FIG. 3, a first sign may indicate a speed limit of 80 kph, and then if driving conditions worsen (such as due to rain or snow or the like), the second sign (such as a sign adjacent the first sign or a sign disposed along the road before or after the first sign) may indicate a reduced speed limit (such as 50 kph), which becomes the speed limit for the road during rain or snow conditions or other poor driving conditions. Such signage is typical in Europe, with both signs installed along the road. As shown in FIG. 3, the 80 kph (speed limit under normal driving conditions) sign has no additional indicia, while the 50 kph (speed limit under snow or rain conditions) sign may have an indicia that indicates snow or rain to indicate that the reduced speed limit applies under such driving conditions. If it is not raining, the driver can speed up to 80 kph, but if it is raining then the driver should drive at or below 50 kph. The system of the present invention is operable to determine the presence of the multiple signs and to display all relevant signs on the display screen or cluster of the vehicle, whereby the driver may then decide which sign is valid under the given traffic conditions. Optionally, the system may, responsive to a signal indicative of the driving conditions, determine the valid speed limit and only display that sign or that speed limit information, so the driver does not have to make that decision. Other signs may indicate a no passing zone or a temporary no passing indication (such as if there is a traffic jam or accident ahead), and the system may determine the presence of such signs and may display those signs or an appropriate one of those signs.

The example shown in FIG. 3 shows the effect of history status and the current input to the system in defining the new state of the system. Traffic Sign Comprehension and display is only an example of such a multi-state system in which the number of currently active states is variable and the new valid states of the system are defined by both the previously valid states of the system and the new input to the system.

The method of the present invention provides a way to achieve two main improvements on such systems: (I) to simplify the implementation of the system in software and (II) to simplify the reuse of the implementation (in other words, when different customers desire or request or require different behaviors, then the change may be a limited configuration change and not a change inside the logic, which means an easier reuse of the solution for different projects/customers).

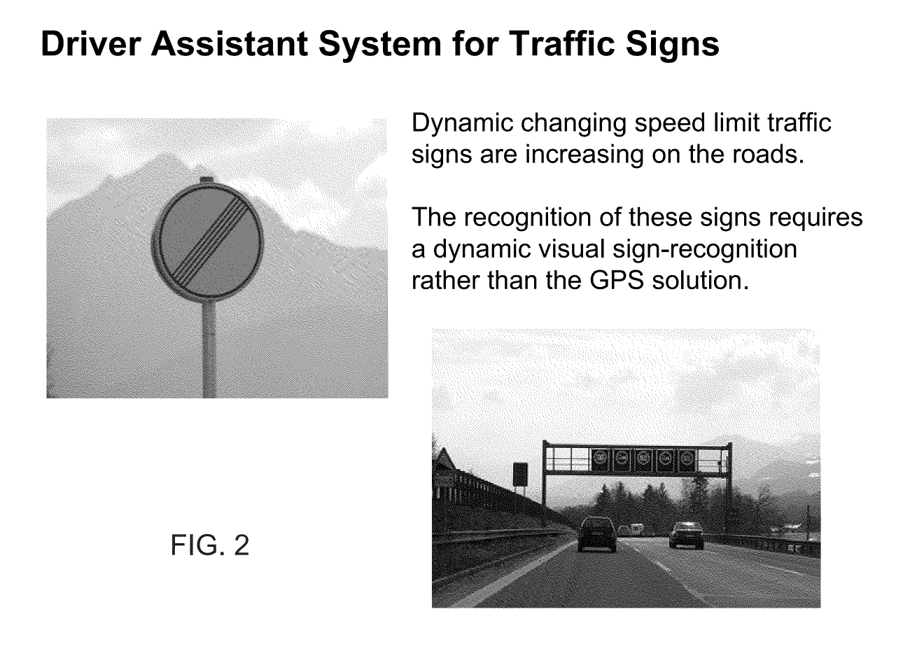

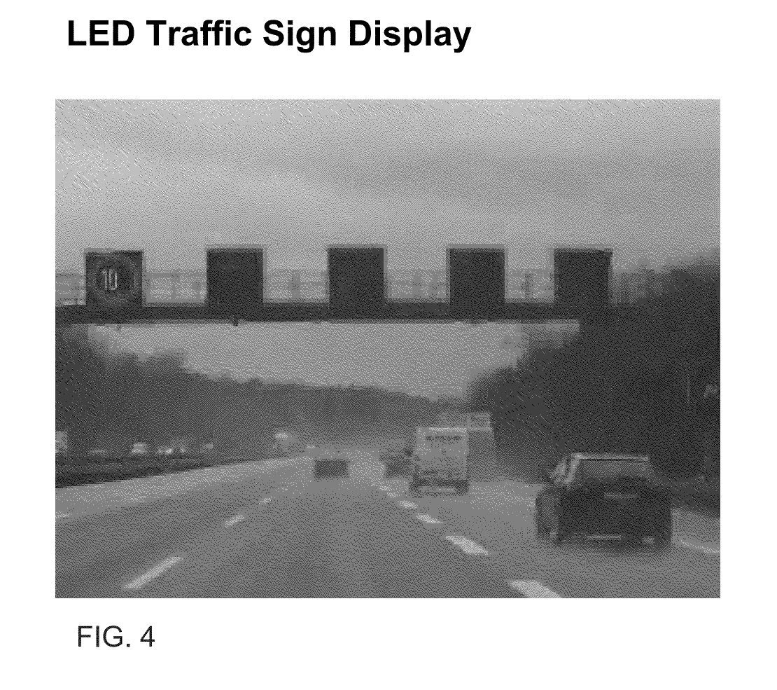

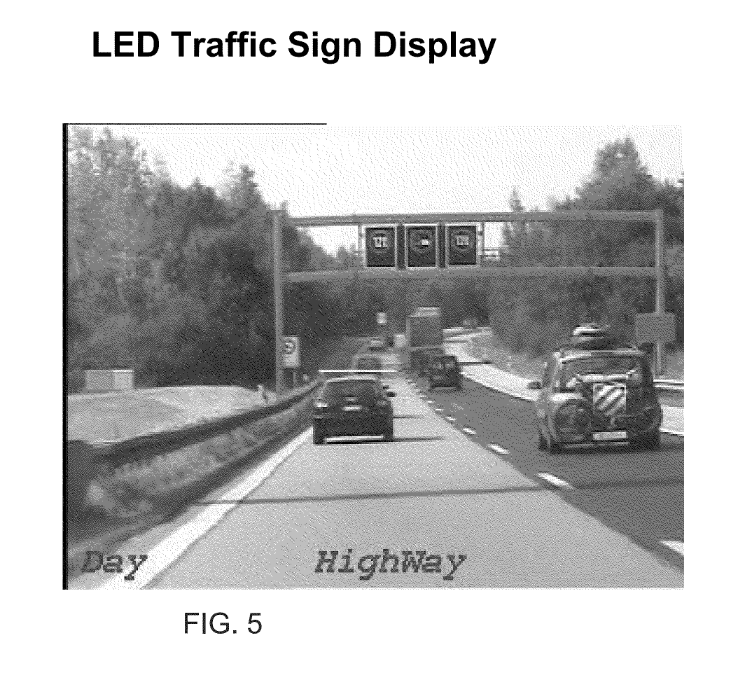

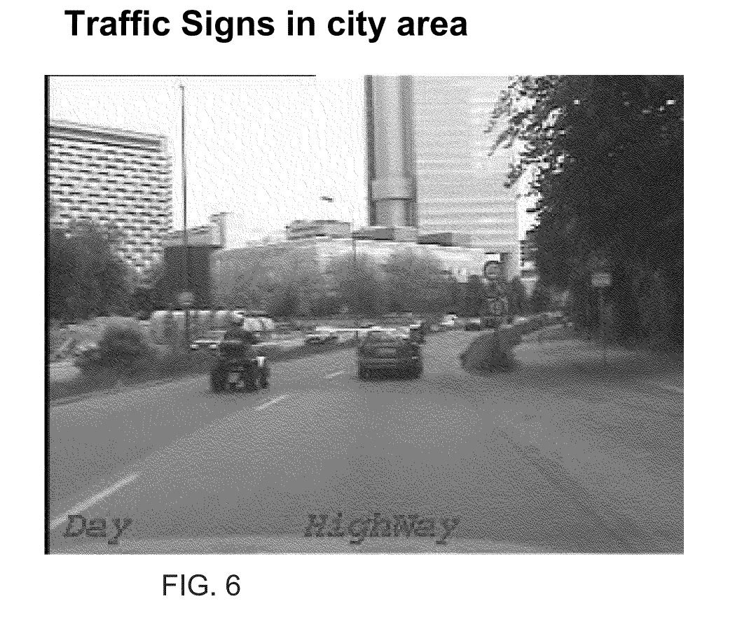

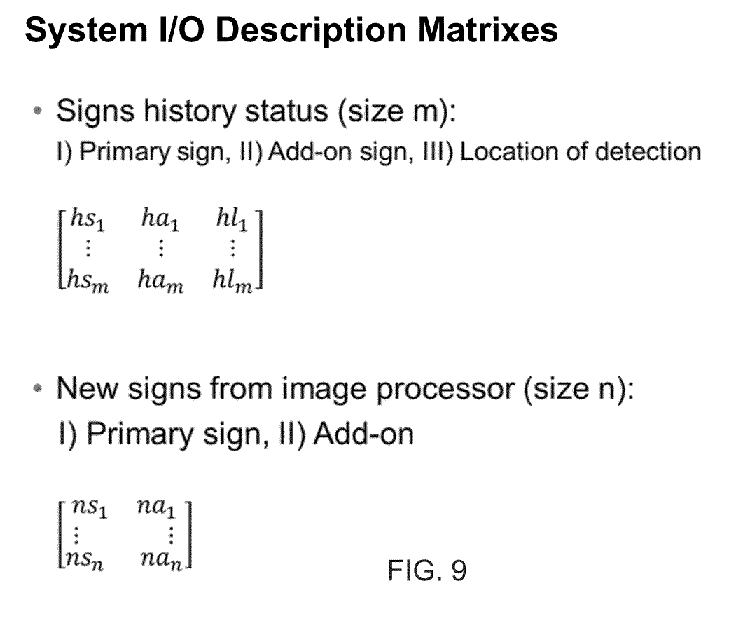

For example, assume for purposes of discussion of the present invention (and with reference to FIGS. 2 and 4-6), that a vehicle passes a pole or structure which has “n” signs, with the signs consisting of a main sign (such as, for example, a speed limit sign that displays the speed limit during dry driving conditions) and possibly an add-on sign (such as, for example, a snow or weather warning or a reduced speed limit sign due to snow or bad weather or driving conditions). The matrix (FIG. 9) describing the input will have a size of nx2 (“ns” and “na” stand for new sign and new add-on, respectively).

$$[ \begin{matrix}n {s}_{1} & {na}_{1} \\ ⋮ & ⋮ \\ n {s}_{n} & {na}_{n}\end{matrix} ]$$

Now assume that currently the system is displaying “m” signs to the driver as all valid. Here the system needs an additional dimension of “I” (location) besides the sign and add-on. The location is important because for some customers the behavior of the system depends also on the distance from the observation of history sign. So the history of this multi-state system will be described by a mx3 matrix (FIG. 9) as below (“hs”, “ha”, and “hl” stand for history sign, history add-on and history location respectively).

$$[ \begin{matrix}{hs}_{1} & {ha}_{1} & {hl}_{1} \\ ⋮ & ⋮ & ⋮ \\ {hs}_{m} & {ha}_{m} & {hl}_{m}\end{matrix} ]$$

Now considering the input to the algorithm (such as the current input and system history), the algorithm determines what the necessary actions are. For example, the algorithm may clear a sign from the display or add a sign to the display and/or the like (in the matrix below, “nha” stands for action for the combination of new and history inputs).

$$[ \begin{matrix}{nha}_{1} \\ ⋮ \\ {nha}_{m + n}\end{matrix} ]$$

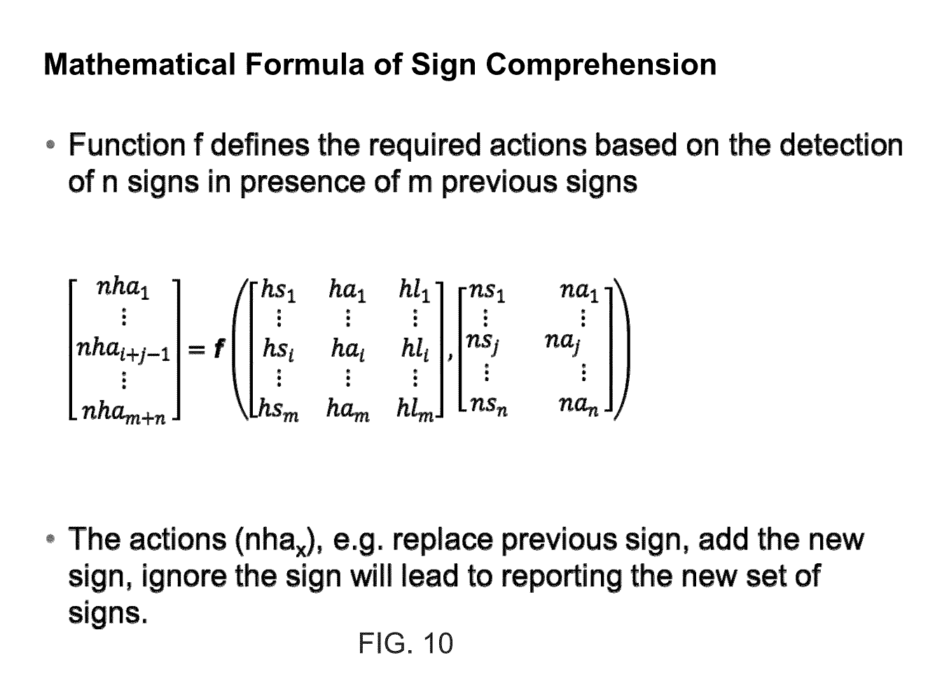

The system behavior can be shown as a function f below (FIG. 10):

$$[ \begin{matrix}{nha}_{1} \\ ⋮ \\ {nha}_{i \to j - 1} \\ ⋮ \\ {nha}_{m + n}\end{matrix} ] = {}_{f} ( [ \begin{matrix}{hs}_{1} & {ha}_{1} & {hl}_{1} \\ ⋮ & ⋮ & ⋮ \\ {hs}_{i} & {ha}_{i} & {hl}_{i} \\ ⋮ & ⋮ & ⋮ \\ {hs}_{m} & {ha}_{m} & {hl}_{m}\end{matrix} ] \cdot [ \begin{matrix}n {s}_{1} & {na}_{1} \\ ⋮ & ⋮ \\ n {s}_{j} & {na}_{j} \\ ⋮ & ⋮ \\ n {s}_{n} & {na}_{n}\end{matrix} ] )$$

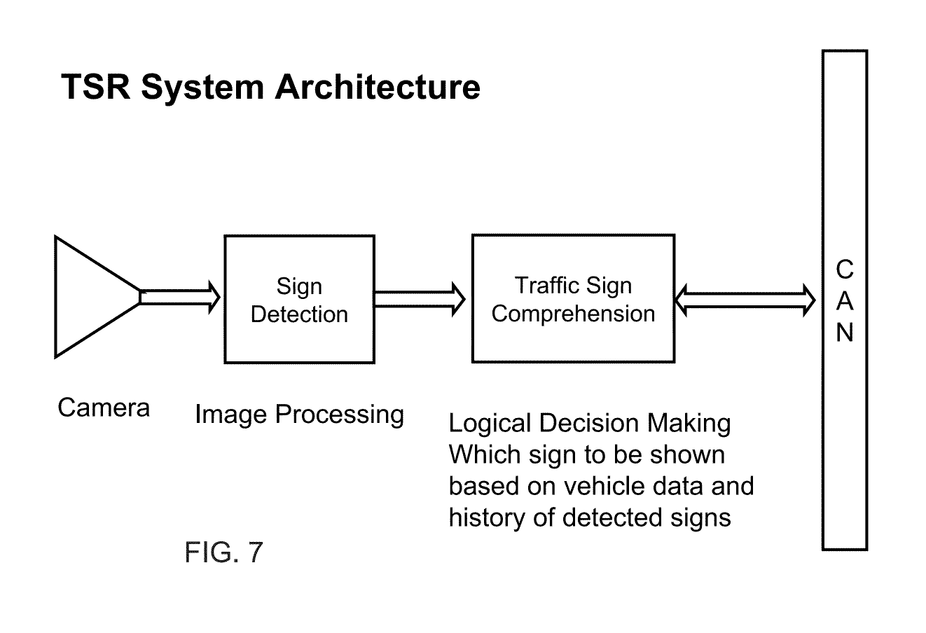

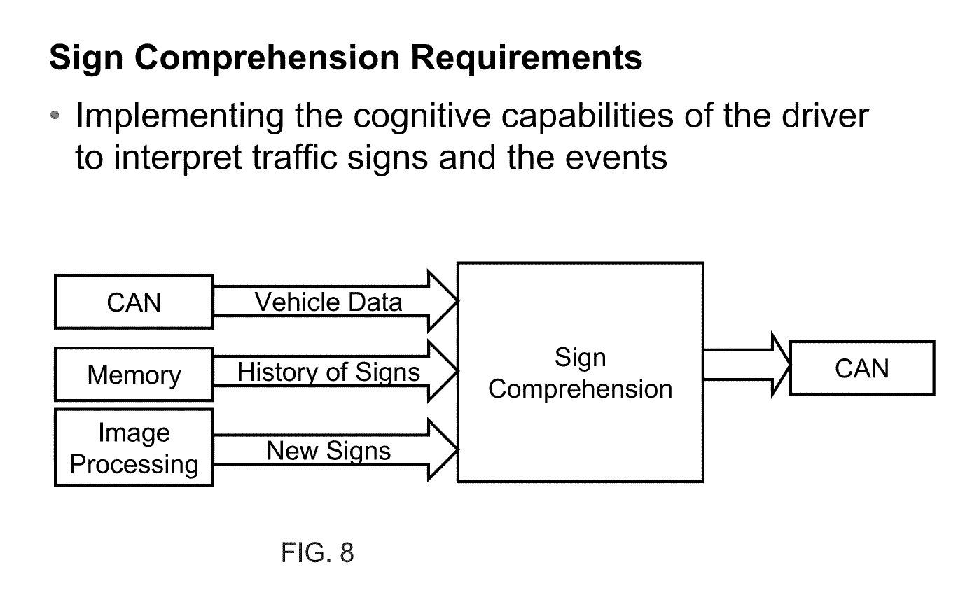

The system architecture for the traffic sign recognition system is shown in FIG. 7, and includes a camera (such as a forward viewing camera), an image processor for processing captured images or image data to detect the presence of a sign along the road ahead of the vehicle, and a processor or logic circuitry that comprehends or recognizes or interprets the determined signs and determines which sign or signs is/are to be displayed or shown to the driver of the vehicle, based on vehicle data (which may be received via a vehicle network bus, such as a CAN bus of the vehicle or the like) and the history of previously detected signs. Optionally, and as shown in FIG. 8, the system may comprehend the traffic signs based on vehicle data, the history of determined signs (stored in the system's memory or the like) and image processing of new signs.

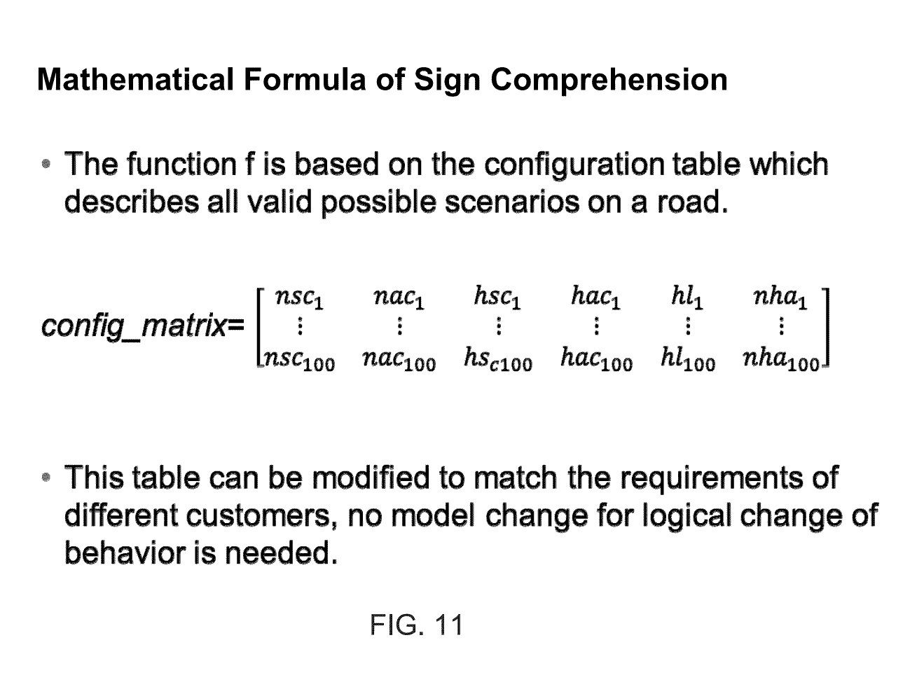

The method of the present invention is all about how to specify the function f to achieve simplicity in implementation and reusability of the result for different customers. The function f may be based on a configuration table that describes the valid possible scenarios on a road (FIG. 11) or a scenario/rule-based table or configurable scenario description table (Table 1). The table comprises 5 columns, with the first four columns representing the system inputs, both current and history data, and the fifth column determining or indicating the action required based on that scenario. Table 1 does not specify scenarios for every single sign value but it uses classifiers. For example, when the history speed limit is 50 and the vehicle passes an 80, then the system replaces the sign. This table will not list all mathematical combinations of speed limits with no add on to define what to do. The system defines one single rule of history traffic sign with no add-on will be replaced with a new traffic sign with no add-on no matter which location. This single rule covers hundreds of all possible mathematical combinations.

$$[ \begin{matrix}n {s}_{1} & {na}_{1} & {hs}_{1} & {ha}_{1} & {hl}_{1} & {nha}_{1} \\ ⋮ & ⋮ & ⋮ & ⋮ & ⋮ & ⋮ \\ n {s}_{10 o} & {na}_{10 o} & {hs}_{10 o} & {ha}_{10 o} & {hl}_{10 o} & {nha}_{10 o}\end{matrix} ]$$

This methodology can be used for any similar multi-state discrete system based on event inputs. The size of history and new input matrix may change based on the number of dimensions needed to specify the state of inputs to the system for a specific application.

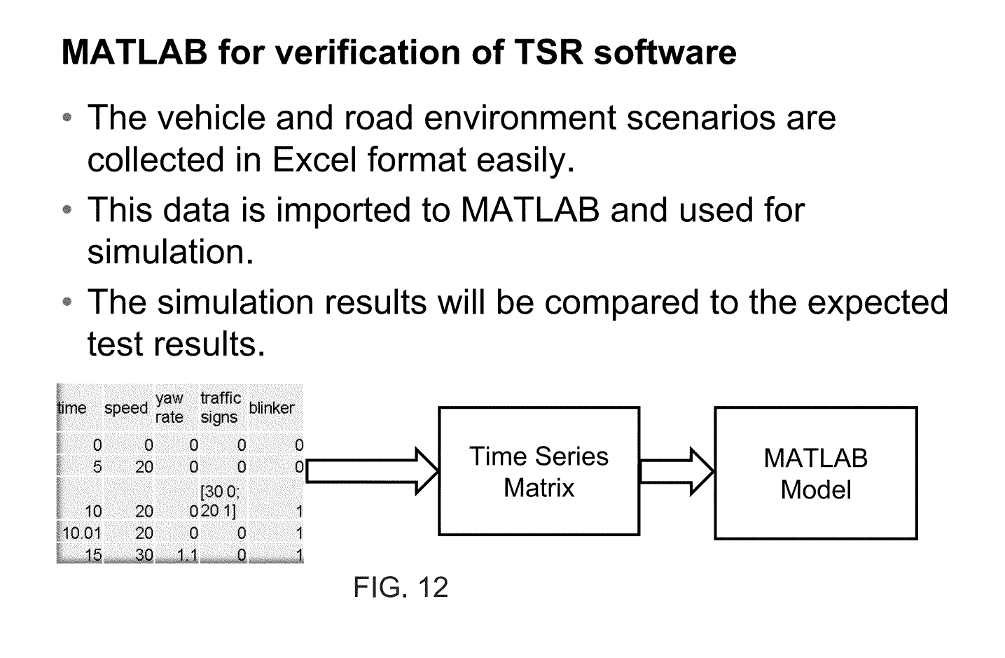

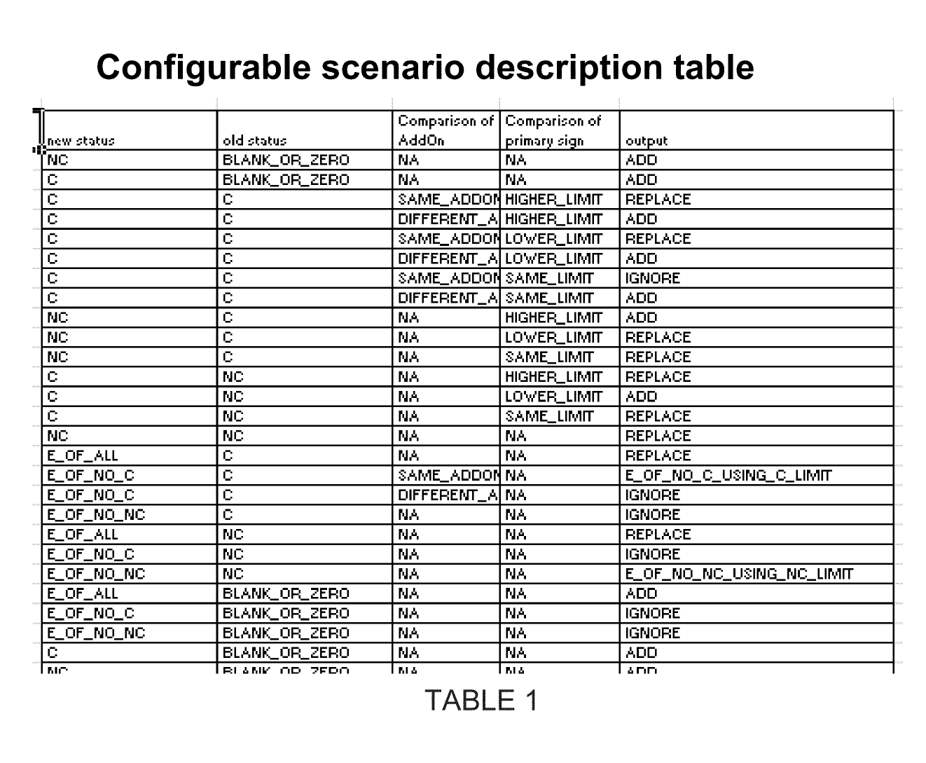

The use of MATLAB for implementation of traffic sign recognition (TSR) software provides for multi-dimensional matrices, with easy declaring of such multi-dimensional matrices, and with the provision of operations on multi-dimensional matrices. Also, the MATLAB code generator avoids the need of manual implementation of matrix operations in C. The use of MATLAB for verification of TSR software (FIG. 12) provides for collection of the vehicle and road environment scenarios in Excel format. This data can be imported to MATLAB and used for simulation, and the simulation results can be compared to expected test results.

The vision system of the present invention thus is operable to detect and recognize traffic signs along the road ahead of the vehicle and to determine or use a history of detected and recognized signs. The system processes image data representative of new signs along the road ahead of the vehicle and determines whether (i) the new sign information replaces or supplants or overrides the previous or historical sign information, (ii) the new sign information adds a further limitation or the like (such as a reduced speed limit due to road or driving conditions or the like) to the previous or historical sign information, and/r (iii) the new sign information is to be ignored. Responsive to such processing, the system may generate an output or alert, such as an output to a display to display the appropriate information for viewing by the driver of the vehicle. The vision system utilizes a matrix algorithm and mathematical models to determine what signs to display to the driver of the vehicle as the vehicle travels along a road and passes multiple signs (such as multiple speed limit signs setting different speed limits for different road regions and/or driving conditions).

Therefore, the present invention utilizes a MATLAB mathematical model to handle and determine traffic scenarios, which helps to simplify the logic and ease the reuse of software components. Implementing the MATLAB code generator also eliminates the need of writing manual C code. The verification of models and reconstructing the problematic scenarios from road tests is enhanced in the MATLAB environment as compared to conventional methods. However, as discussed above, the system of the present invention may utilize C code or other suitable code or algorithm to model the system and generate the appropriate code and/or outputs.

Thus, the system of the present invention is useful in processing captured image data (such as captured video image data captured by one or more forward facing cameras of the vehicle) to determine and identify and/or comprehend traffic signs along the road being traveled by the vehicle. Optionally, and although described above as processing captured image data, the system of the present invention is suitable for use in any similar data capture or generation system, such as for use in a radar system, an ultrasound system, a lidar system, a ladar system and/or a magnetic sensor system and/or any type of system with current multi-dimensional input and previous multi-dimensional state. Optionally, the system may utilize sensor fusion, such as camera and radar sensor fusion or the like, such as by utilizing aspects of the systems described in U.S. Pat. No. 8,013,780, which is hereby incorporated herein by reference in its entirety.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an EyeQ2 or EyeQ3 image processing chip available from Mobileye Vision Technologies Ltd. of Jerusalem, Israel, and may include object detection software (such as the types described in U.S. Pat. Nos. 7,855,755; 7,720,580; and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or International Publication Nos. WO 2011/028686; WO 2010/099416; WO 2012/061567; WO 2012/068331; WO 2012/075250; WO 2012/103193; WO 2012/0116043; WO 2012/0145313; WO 2012/0145501; WO 2012/145818; WO 2012/145822; WO 201 2/1 581 67; WO 2012/075250; WO 2012/0116043; WO 2012/0145501; WO 2012/154919; WO 2013/019707; WO 2013/016409; WO 2013/019795; WO 2013/067083; WO 2013/070539; WO 2013/043661; WO 2013/048994; WO 2013/063014, WO 2013/081984; WO 2013/081985; WO 2013/074604; WO 2013/086249; WO 2013/103548; WO 2013/109869; WO 2013/123161; WO 2013/126715; WO 2013/043661 and/or WO 2013/158592, and/or U.S. patent applications, Ser. No. 14/242,038, filed Apr. 1, 2014 (Attorney Docket MAG04 P-2255); Ser. No. 14/229,061, filed Mar. 28, 2014 (Attorney Docket MAG04 P-2246); Ser. No. 14/343,937, filed Mar. 10, 2014 (Attorney Docket MAG04 P-1942); Ser. No. 14/343,936, filed Mar. 10, 2014 (Attorney Docket MAG04 P-1937); Ser. No. 14/195,135, filed Mar. 3, 2014 (Attorney Docket MAG04 P-2237); Ser. No. 14/195,136, filed Mar. 3, 2014 (Attorney Docket MAG04 P-2238); Ser. No. 14/191,512, filed Feb. 27, 2014 (Attorney Docket No. MAG04 P-2228); Ser. No. 14/183,613, filed Feb. 19, 2014 (Attorney Docket No. MAG04 P-2225); Ser. No. 14/169,329, filed Jan. 31, 2014 (Attorney Docket MAG04 P-2218); Ser. No. 14/169,328, filed Jan. 31, 2014 (Attorney Docket MAG04 P-2217); Ser. No. 14/163,325, filed Jan. 24, 2014 (Attorney Docket No. MAG04 P-2216); Ser. No. 14/159,772, filed Jan. 21, 2014 (Attorney Docket MAG04 P2215); Ser. No. 14/107,624, filed Dec. 16, 2013 (Attorney Docket MAG04 P-2206); Ser. No. 14/102,981, filed Dec. 11, 2013 (Attorney Docket MAG04 P-2196); Ser. No. 14/102,980, filed Dec. 11, 2013 (Attorney Docket MAG04 P-2195); Ser. No. 14/098,817, filed Dec. 6, 2013 (Attorney Docket MAG04 P-2193); Ser. No. 14/097,581, filed Dec. 5, 2013 (Attorney Docket MAG04 P-2192); Ser. No. 14/093,981, filed Dec. 2, 2013 (Attorney Docket MAG04 P-2197); Ser. No. 14/093,980, filed Dec. 2, 2013 (Attorney Docket MAG04 P-2191); Ser. No. 14/082,573, filed Nov. 18, 2013 (Attorney Docket MAG04 P-2183); Ser. No. 14/082,574, filed Nov. 18, 2013 (Attorney Docket MAG04 P-2184); Ser. No. 14/082,575, filed Nov. 18, 2013 (Attorney Docket MAG04 P-2185); Ser. No. 14/082,577, filed Nov. 18, 2013 (Attorney Docket MAG04 P-2203); Ser. No. 14/071,086, filed Nov. 4, 2013 (Attorney Docket MAG04 P2208); Ser. No. 14/076,524, filed Nov. 11, 2013 (Attorney Docket MAG04 P-2209); Ser. No. 14/052,945, filed Oct. 14, 2013 (Attorney Docket MAG04 P-2165); Ser. No. 14/046,174, filed Oct. 4, 2013 (Attorney Docket MAG04 P-2158); Ser. No. 14/016,790, filed Oct. 3, 2013 (Attorney Docket MAG04 P-2139); Ser. No. 14/036,723, filed Sep. 25, 2013 (Attorney Docket MAG04 P-2148); Ser. No. 14/016,790, filed Sep. 3, 2013 (Attorney Docket MAG04 P-2139); Ser. No. 14/001,272, filed Aug. 23, 2013 (Attorney Docket MAG04 P-1824); Ser. No. 13/970,868, filed Aug. 20, 2013 (Attorney Docket MAG04 P-2131); Ser. No. 13/964,134, filed Aug. 12, 2013 (Attorney Docket MAG04 P-2123); Ser. No. 13/942,758, filed Jul. 16, 2013 (Attorney Docket MAG04 P-2127); Ser. No. 13/942,753, filed Jul. 16, 2013 (Attorney Docket MAG04 P-2112); Ser. No. 13/927,680, filed Jun. 26, 2013 (Attorney Docket MAG04 P-2091); Ser. No. 13/916,051, filed Jun. 12, 2013 (Attorney Docket MAG04 P-2081); Ser. No. 13/894,870, filed May 15, 2013 (Attorney Docket MAG04 P-2062); Ser. No. 13/887,724, filed May 6, 2013 (Attorney Docket MAG04 P-2072); Ser. No. 13/852,190, filed Mar. 28, 2013 (Attorney Docket MAG04 P-2046); Ser. No. 13/851,378, filed Mar. 27, 2013 (Attorney Docket MAG04 P-2036); Ser. No. 13/848,796, filed Mar. 22, 2012 (Attorney Docket MAG04 P-2034); Ser. No. 13/847,815, filed Mar. 20, 2013 (Attorney Docket MAG04 P-2030); Ser. No. 13/800,697, filed Mar. 13, 2013 (Attorney Docket MAG04 P-2060); Ser. No. 13/785,099, filed Mar. 5, 2013 (Attorney Docket MAG04 P-2017); Ser. No. 13/779,881, filed Feb. 28, 2013 (Attorney Docket MAG04 P-2028); Ser. No. 13/774,317, filed Feb. 22, 2013 (Attorney Docket MAG04 P-2015); Ser. No. 13/774,315, filed Feb. 22, 2013 (Attorney Docket MAG04 P-2013); Ser. No. 13/681,963, filed Nov. 20, 2012 (Attorney Docket MAG04 P-1983); Ser. No. 13/660,306, filed Oct. 25, 2012 (Attorney Docket MAG04 P-1950); Ser. No. 13/653,577, filed Oct. 17, 2012 (Attorney Docket MAG04 P-1948); and/or Ser. No. 13/534,657, filed Jun. 27, 2012 (Attorney Docket MAG04 P-1892), and/or U.S. provisional applications, Ser. No. 61/972,708, filed Mar. 31, 2014; Ser. No. 61/972,707, filed Mar. 31, 2014; Ser. No. 61/969,474, filed Mar. 24, 2014; Ser. No. 61/955,831, filed Mar. 20, 2014; Ser. No. 61/952,335, filed Mar. 13, 2014; Ser. No. 61/952,334, filed Mar. 13, 2014; Ser. No. 61/950,261, filed Mar. 10, 2014; Ser. No. 61/950,261, filed Mar. 10, 2014; Ser. No. 61/947,638, filed Mar. 4, 2014; Ser. No. 61/947,053, filed Mar. 3, 2014; Ser. No. 61/942,568, filed Feb. 19, 2014; Ser. No. 61/935,485, filed Feb. 4, 2014; Ser. No. 61/935,057, filed Feb. 3, 2014; Ser. No. 61/935,056, filed Feb. 3, 2014; Ser. No. 61/935,055, filed Feb. 3, 2014; Ser. 61/931,811, filed Jan. 27, 2014; Ser. No. 61/919,129, filed Dec. 20, 2013; Ser. No. 61/919,130, filed Dec. 20, 2013; Ser. No. 61/919,131, filed Dec. 20, 2013; Ser. No. 61/919,147, filed Dec. 20, 2013; Ser. No. 61/919,138, filed Dec. 20, 2013, Ser. No. 61/919,133, filed Dec. 20, 2013; Ser. No. 61/918,290, filed Dec. 19, 2013; Ser. No. 61/915,218, filed Dec. 12, 2013; Ser. No. 61/912,146, filed Dec. 5, 2013; Ser. No. 61/911,666, filed Dec. 4, 2013; Ser. No. 61/911,665, filed Dec. 4, 2013; Ser. No. 61/905,461, filed Nov. 18, 2013; Ser. No. 61/905,462, filed Nov. 18, 2013; Ser. No. 61/901,127, filed Nov. 7, 2013; Ser. No. 61/895,610, filed Oct. 25, 2013; Ser. No. 61/895,609, filed Oct. 25, 2013; Ser. No. 61/879,837, filed Sep. 19, 2013; Ser. No. 61/879,835, filed Sep. 19, 2013; Ser. No. 61/878,877, filed Sep. 17, 2013; Ser. No. 61/875,351, filed Sep. 9, 2013; Ser. No. 61/869,195, filed. Aug. 23, 2013; Ser. No. 61/864,835, filed Aug. 12, 2013; Ser. No. 61/864,836, filed Aug. 12, 2013; Ser. No. 61/864,837, filed Aug. 12, 2013; Ser. No. 61/864,838, filed Aug. 12, 2013; Ser. No. 61/856,843, filed Jul. 22, 2013, Ser. No. 61/845,061, filed Jul. 11, 2013; Ser. No. 61/844,630, filed Jul. 10, 2013; Ser. No. 61/844,173, filed Jul. 9, 2013; Ser. No. 61/844,171, filed Jul. 9, 2013; Ser. No. 61/842,644, filed Jul. 3, 2013; Ser. No. 61/840,542, filed Jun. 28, 2013; Ser. No. 61/838,619, filed Jun. 24, 2013; Ser. No. 61/838,621, filed Jun. 24, 2013; Ser. No. 61/837,955, filed Jun. 21, 2013; Ser. No. 61/836,900, filed Jun. 19, 2013; Ser. No. 61/836,380, filed Jun. 18, 2013; Ser. No. 61/833,080, filed Jun. 10, 2013; Ser. No. 61/830,375, filed Jun. 3, 2013; Ser. No. 61/830,377, filed Jun. 3, 2013; Ser. No. 61/825,752, filed May 21, 2013; Ser. No. 61/825,753, filed May 21, 2013; Ser. No. 61/823,648, filed May 15, 2013; Ser. No. 61/823,644, filed May 15, 2013; Ser. No. 61/821,922, filed May 10, 2013; Ser. No. 61/819,835, filed May 6, 2013; Ser. No. 61/816,956, filed Apr. 29, 2013; Ser. No. 61/815,044, filed Apr. 23, 2013; Ser. No. 61/814,533, filed Apr. 22, 2013; Ser. No. 61/813,361, filed Apr. 18, 2013; and/or Ser. No. 61/810,407, filed Apr. 10, 2013, which are all hereby incorporated herein by reference in their entireties. The system may communicate with other communication systems via any suitable means, such as by utilizing aspects of the systems described in International Publication Nos. WO/2010/144900; WO 2013/043661 and/or WO 2013/081985, and/or U.S. patent application Ser. No. 13/202,005, filed Aug. 17, 2011 (Attorney Docket MAG04 P-1595), which are hereby incorporated herein by reference in their entireties.

The imaging device and control and image processor and any associated illumination source, if applicable, may comprise any suitable components, and may utilize aspects of the cameras and vision systems described in U.S. Pat. Nos. 5,550,677; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454; and/or 6,824,281, and/or International Publication Nos. WO 2010/099416; WO 2011/028686; and/or WO 2013/016409, and/or U.S. Pat. Publication No. US 2010-0020170, and/or U.S. patent application Ser. No. 13/534,657, filed Jun. 27, 2012 (Attorney Docket MAG04 P-1892), which are all hereby incorporated herein by reference in their entireties. The camera or cameras may comprise any suitable cameras or imaging sensors or camera modules, and may utilize aspects of the cameras or sensors described in U.S. Publication No. US-2009-0244361 and/or U.S. patent application Ser. No. 13/260,400, filed Sep. 26, 2011 (Attorney Docket MAG04 P-1757), and/or U.S. Pat. Nos. 7,965,336 and/or 7,480,149, which are hereby incorporated herein by reference in their entireties. The imaging array sensor may comprise any suitable sensor, and may utilize various imaging sensors or imaging array sensors or cameras or the like, such as a CMOS imaging array sensor, a CCD sensor or other sensors or the like, such as the types described in U.S. Pat. Nos. 5,550,677; 5,670,935; 5,760,962; 5,715,093; 5,877,897; 6,922,292; 6,757,109; 6,717,610; 6,590,719; 6,201,642; 6,498,620; 5,796,094; 6,097,023; 6,320,176; 6,559,435; 6,831,261; 6,806,452; 6,396,397; 6,822,563; 6,946,978; 7,339,149; 7,038,577; 7,004,606; 7,720,580; and/or 7,965,336, and/or International Publication Nos. WO/2009/036176 and/or WO/2009/046268, which are all hereby incorporated herein by reference in their entireties.

The camera module and circuit chip or board and imaging sensor may be implemented and operated in connection with various vehicular vision-based systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; 6,831,261; 7,004,606; 7,339,149; and/or 7,526,103, which are all hereby incorporated herein by reference in their entireties, a rain sensor, such as the types disclosed in commonly assigned U.S. Pat. Nos. 6,353,392; 6,313,454; 6,320,176; and/or 7,480,149, which are hereby incorporated herein by reference in their entireties, a vehicle vision system, such as a forwardly, sidewardly or rearwardly directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; and/or 7,859,565, which are all hereby incorporated herein by reference in their entireties, a trailer hitching aid or tow check system, such as the type disclosed in U.S. Pat. No. 7,005,974, which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 7,881,496; 7,720,580; 7,038,577; 5,929,786 and/or 5,786,772, and/or U.S. provisional applications, Ser. No. 60/628,709, filed Nov. 17, 2004; Ser. No. 60/614,644, filed Sep. 30, 2004; Ser. No. 60/618,686, filed Oct. 14, 2004; Ser. No. 60/638,687, filed Dec. 23, 2004, which are hereby incorporated herein by reference in their entireties, a video device for internal cabin surveillance and/or video telephone function, such as disclosed in U.S. Pat. Nos. 5,760,962; 5,877,897; 6,690,268; and/or 7,370,983, and/or U.S. Publication No. US-2006-0050018, which are hereby incorporated herein by reference in their entireties, a traffic sign recognition system, a system for determining a distance to a leading or trailing vehicle or object, such as a system utilizing the principles disclosed in U.S. Pat. Nos. 6,396,397 and/or 7,123,168, which are hereby incorporated herein by reference in their entireties, and/or the like.

Optionally, the circuit board or chip may include circuitry for the imaging array sensor and or other electronic accessories or features, such as by utilizing compass-on-a-chip or EC driver-on-a-chip technology and aspects such as described in U.S. Pat. No. 7,255,451 and/or U.S. Pat. No. 7,480,149; and/or U.S. Publication No. US-2006-0061008, and/or U.S. patent application Ser. No. 12/578,732, filed Oct. 14, 2009 (Attorney Docket DON01 P-1564), which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device disposed at or in the interior rearview mirror assembly of the vehicle, such as by utilizing aspects of the video mirror display systems described in U.S. Pat. No. 6,690,268 and/or U.S. patent application Ser. No. 13/333,337, filed Dec. 21, 2011 (Attorney Docket DON01 P-1797), which are hereby incorporated herein by reference in their entireties. The video mirror display may comprise any suitable devices and systems and optionally may utilize aspects of the compass display systems described in U.S. Pat. Nos. 7,370,983; 7,329,013; 7,308,341; 7,289,037; 7,249,860; 7,004,593; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; 6,513,252; and/or 6,642,851, and/or European patent application, published Oct. 11, 2000 under Publication No. EP 0 1043566, and/or U.S. Publication No. US-2006-0061008, which are all hereby incorporated herein by reference in their entireties. Optionally, the video mirror display screen or device may be operable to display images captured by a rearward viewing camera of the vehicle during a reversing maneuver of the vehicle (such as responsive to the vehicle gear actuator being placed in a reverse gear position or the like) to assist the driver in backing up the vehicle, and optionally may be operable to display the compass heading or directional heading character or icon when the vehicle is not undertaking a reversing maneuver, such as when the vehicle is being driven in a forward direction along a road (such as by utilizing aspects of the display system described in International Publication No. WO 2012/051500, which is hereby incorporated herein by reference in its entirety).

Optionally, the vision system (utilizing the forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described in International Publication Nos. WO 2010/099416; WO 2011/028686; WO2012/075250; WO 2013/019795; WO 2012/075250; WO 2012/145822; WO 2013/081985; WO 2013/086249; and/or WO 2013/109869, and/or U.S. patent application Ser. No. 13/333,337, filed Dec. 21, 2011 (Attorney Docket DON01 P-1797), which are hereby incorporated herein by reference in their entireties.

Optionally, a video mirror display may be disposed rearward of and behind the reflective element assembly and may comprise a display such as the types disclosed in U.S. Pat. Nos. 5,530,240; 6,329,925; 7,855,755; 7,626,749; 7,581,859; 7,446,650; 7,370,983; 7,338,177; 7,274,501; 7,255,451; 7,195,381; 7,184,190; 5,668,663; 5,724,187 and/or 6,690,268, and/or in U.S. Publication Nos. US-2006-0061008 and/or US-2006-0050018, which are all hereby incorporated herein by reference in their entireties. The display is viewable through the reflective element when the display is activated to display information. The display element may be any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like. The mirror assembly and/or display may utilize aspects described in U.S. Pat. Nos. 7,184,190; 7,255,451; 7,446,924 and/or 7,338,177, which are all hereby incorporated herein by reference in their entireties. The thicknesses and materials of the coatings on the substrates of the reflective element may be selected to provide a desired color or tint to the mirror reflective element, such as a blue colored reflector, such as is known in the art and such as described in U.S. Pat. Nos. 5,910,854; 6,420,036; and/or 7,274,501, which are hereby incorporated herein by reference in their entireties.

Optionally, the display or displays and any associated user inputs may be associated with various accessories or systems, such as, for example, a tire pressure monitoring system or a passenger air bag status or a garage door opening system or a telematics system or any other accessory or system of the mirror assembly or of the vehicle or of an accessory module or console of the vehicle, such as an accessory module or console of the types described in U.S. Pat. Nos. 7,289,037; 6,877,888; 6,824,281; 6,690,268; 6,672,744; 6,386,742; and/or 6,124,886, and/or U.S. Publication No. US-2006-0050018, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vision system of a vehicle, said vision system comprising:
a camera disposed at a vehicle and having a field of view forward of the vehicle;
wherein said camera comprises a two dimensional imaging array of a plurality of photosensing pixels;
wherein said camera is operable to capture image data;
a control comprising an image processor operable to process image data captured by said camera; and
wherein said control, responsive at least in part to processing by said image processor of captured image data, is operable to determine road signs ahead of the vehicle, and wherein said control uses a matrix algorithm for determining road signs for display of sign information to the driver of the vehicle.

2. The vision system of claim 1, wherein the determined road signs comprise speed limit signs and wherein, responsive at least in part to image processing of captured image data, said control determines different speed limit signs and determines an appropriate speed limit for the vehicle at the vehicle's current location.

3. The vision system of claim 2, wherein, responsive at least in part to driving conditions at the vehicle, said control determines an appropriate speed limit for the vehicle.

4. The vision system of claim 3, wherein, responsive at least in part to a determination of weather conditions at the vehicle's current location, said control determines the appropriate speed limit.

5. The vision system of claim 4, wherein the determined weather conditions comprise one of rain and snow.

6. The vision system of claim 1, wherein, responsive at least in part to image processing of captured image data, said control generates an output for displaying appropriate sign information to the driver of the vehicle.

7. The vision system of claim 6, comprising a display screen viewable by a driver of the vehicle and operable to display the appropriate sign information responsive to said output.

8. The vision system of claim 1, wherein said control is operable to utilize newly determined road signs and previously determined road signs in determining whether new sign information of a newly determined road sign supplants previous sign information of previously determined road signs.

9. The vision system of claim 8, wherein, responsive to a determination that new sign information supplants previous sign information, said vision system outputs to a display screen to display the new sign information for viewing by the driver of the vehicle.

10. The vision system of claim 1, wherein, responsive at least in part to image processing of captured image data, said control determines the presence of multiple speed limit signs at or along a road region on which the vehicle is traveling, and wherein said control stores data indicative of the determined speed limit signs.

11. The vision system of claim 10, wherein said control determines at least one speed limit sign to display to the driver of the vehicle.

12. The vision system of claim 11, wherein, responsive at least in part to image processing of captured image data, said image processor is operable to determine the current speed limit for the current location of the vehicle and for a determined current road condition, and wherein said vision system displays the current speed limit for viewing by the driver of the vehicle.

13. The vision system of claim 10, wherein, responsive at least in part to image processing of captured image data, said control determines the presence of a first speed limit sign and a second speed limit sign, wherein said first speed limit sign indicates a first speed limit that is applicable during dry road conditions and wherein said second speed limit sign indicates a second speed limit that is applicable during wet road conditions, and wherein, responsive at least in part to the determined current road condition, said control is operable to determine which of the first and second speed limits is applicable to the current road conditions and is operable to display the determined appropriate speed limit for viewing by the driver of the vehicle.

14. The vision system of claim 13, wherein said vision system is operable to store sign data as a matrix and said matrix algorithm is operable to process said matrix to determine appropriate sign information for display to the driver.

15. The vision system of claim 14, wherein said vision system is operable to store location data as part of said matrix.

16. A vision system of a vehicle, said vision system comprising:
a camera disposed at a vehicle and having a field of view forward of the vehicle;
wherein said camera comprises a two dimensional imaging array of a plurality of photosensing pixels;
wherein said camera is operable to capture image data;
a control comprising an image processor operable to process image data captured by said camera;
wherein said control, responsive at least in part to processing by said image processor of captured image data, is operable to determine road signs ahead of the vehicle, and wherein said control uses a matrix algorithm for determining road signs for display of sign information to the driver of the vehicle; and
wherein, responsive at least in part to image processing of captured image data, said control determines the presence of a first road sign and a second road sign, wherein said first road sign indicates first information that is applicable during dry road conditions and wherein said second road sign indicates second information that is applicable during wet road conditions, and wherein said control is operable to determine which of the first and second road signs is applicable to a determined current road condition and is operable to display the determined appropriate information for viewing by the driver of the vehicle.

17. The vision system of claim 16, wherein said vision system is operable to store sign information and location data as a matrix and said matrix algorithm is operable to process said matrix to determine appropriate information for display to the driver.

18. The vision system of claim 17, wherein said first road sign comprises a first speed limit sign indicating a first speed limit and said second road sign comprises a second speed limit sign indicating a second speed limit, and wherein said second speed limit comprises a lower speed limit than said first speed limit.

19. A vision system of a vehicle, said vision system comprising:
a camera disposed at a vehicle and having a field of view forward of the vehicle;
wherein said camera comprises a two dimensional imaging array of a plurality of photosensing pixels;
wherein said camera is operable to capture image data;
a control comprising an image processor operable to process image data captured by said camera;
wherein said control, responsive at least in part to processing by said image processor of captured image data, is operable to determine speed limit signs ahead of the vehicle, and wherein said control uses a matrix algorithm for determining speed limit signs for display of an appropriate speed limit to the driver of the vehicle;
wherein, responsive at least in part to image processing of captured image data and responsive at least in part to a determination of a weather condition at the vehicle's current location, said control determines the appropriate speed limit for the vehicle at the vehicle's current location; and
wherein said control generates an output for displaying the appropriate speed limit at a display screen that is viewable by the driver of the vehicle.

20. The vision system of claim 19, wherein said control is operable to utilize newly determined speed limit signs and determined speed limit signs in determining whether new speed limit information of a newly determined speed limit sign supplants previous speed limit information of previously determined speed limit signs, and wherein, responsive to a determination that new speed limit information supplants previous speed limit information, said vision system outputs to a display screen to display the new speed limit information for viewing by the driver of the vehicle.
